(19) United States
(12) Patent Application Publication
(10) Pub. No.: US 2025/0334331 A1
(43) Pub. Date: Oct. 30, 2025

(54) METHOD AND APPARATUS FOR LOW-TEMPERATURE SEPARATION OF A GAS CONTAINING CO2 TO PRODUCE A CO2-RICH FLUID

(71) Applicant: L'Air Liquide, Societe Anonyme pour l'Etude et l’Exploitation des Procedes Georges Claude, Paris (FR)

(72) Inventors: Michele MURINO, Champigny Sur Marne (FR); Ludovic GRANADOS, Champigny Sur Marne (FR); Abigail BONIFACIO, Houston, TX (US)

(21) Appl. No.: 18/866,752

(22) PCT Filed: May 15, 2023
(86) PCT No.: PCT/EP2023/063035

§ 371 Date: Nov. 18, 2024

Related U.S. Application Data
(60) Provisional application No. 63/343,281, filed on May 18, 2022.

(30) Foreign Application Priority Data
Jul. 29, 2022 (FR) FR 2207891
Jul. 29, 2022 (FR) FR 2207892

(51) Int. Cl. F25J 3/02

(52) U.S. Cl. CPC F25J 3/0266

(57) ABSTRACT

The invention relates to a method for the low-temperature separation of a feed gas containing CO₂, at least one component lighter than CO₂ and at least one component heavier than CO₂, wherein, in order to produce a CO₂-rich fluid, the feed gas is compressed, the compressed gas being cooled in a first heat exchanger, the gas cooled in the first heat exchanger is separated at low temperature in a first distillation column to produce a liquid that is enriched in CO₂ and depleted in the at least one component lighter than CO₂ and a gas that is depleted in CO₂ and enriched in the at least one component lighter than CO₂, the gas depleted in CO₂ is heated in the first heat exchanger, a first part of the liquid enriched in CO₂ is expanded and sent to a second distillation column in liquid form, a second part of the liquid enriched in CO₂ is vaporized in the first heat exchanger then sent in gas form into the tank of the second distillation column, a liquid depleted in CO₂ and enriched in the at least one heavier component is withdrawn from the second column, and a gas enriched in CO₂ and depleted in the at least one heavier component is withdrawn at the top of the second column as product.

### CROSS REFERENCE TO RELATED APPLICATIONS

This application is a § 371 of International PCT Application PCT/EP2023/063035, filed May 15, 2023, which claims the benefit of FR2207891, filed Jul. 29, 2022, FR2207892, filed Jul. 29, 2022, and U.S. Provisional 63/343,281, filed May 18, 2022, all of which are herein incorporated by reference in their entireties.

### FIELD OF THE INVENTION

The present invention relates to a process and appliance for the low-temperature separation of a gas containing CO₂ to produce a CO₂-rich fluid. The mixture to be separated contains CO₂, at least one component heavier than CO₂, such as NO₂ , and at least one component lighter than CO₂, such as carbon monoxide, hydrogen, nitrogen, oxygen, NO or methane.

In particular, the process can treat a gas resulting from combustion, for example an oxy-combustion process, a boiler, an SMR, to form a CO₂-rich product, for example containing at least 80 mol % of CO₂, indeed even at least 90 mol % of CO₂.

### BACKGROUND OF THE INVENTION

A gas containing CO₂, for example a waste gas from an H₂ PSA or a CO₂ PSA.

A low-temperature separation operates at temperatures below 0° C., indeed even below −40° C.

It is known, from “A Study of the Extraction of CO₂ from the Flue Gas of a 500 MW Pulverized Coal Fired Boiler” by Allam et al., Energy Conversion and Management, Vol. 33, No. 5-8, 1992, to separate flue gases containing CO₂ in a first distillation column to produce a liquid enriched in CO₂ and depleted in a lighter component and a gas depleted in CO₂ and enriched in the lighter component. A gas from the first distillation column is separated in a second distillation column to form a liquid enriched in a heavy component and a gas enriched in CO₂, which is the product of the process.

The present invention feeds the second column with a first part of the liquid enriched in CO₂ is expanded and sent to a second distillation column in the liquid form, and also a second part of the liquid enriched in CO₂ is vaporized in the first heat exchanger and then sent in the gaseous form into the bottom of the second distillation column at an arrival point, the first part of the liquid being sent to the second column at a level above the arrival point of the second part of the liquid.

This vaporization of liquid contributes to the thermal equilibrium of the process and makes possible the operation of the second column as a stripping column, the first part of the liquid acting as scrubbing gas.

### SUMMARY OF THE INVENTION

According to certain embodiments of the invention, there is provided a process for the low-temperature separation of a feed gas containing CO₂, at least one component lighter than CO₂ and at least one component heavier than CO₂ to produce a CO₂-rich fluid, in which the feed gas is compressed in a compressor comprising at least two stages, the compressed gas being cooled in a first heat exchanger, the gas cooled in the first heat exchanger is separated at low temperature at least by distillation in a first distillation column to produce a liquid enriched in CO₂ and depleted in the at least one component lighter than CO₂ and a gas depleted in CO₂ and enriched in the at least one component lighter than CO₂, the gas depleted in CO₂ is heated in the first heat exchanger, a liquid depleted in CO₂ and enriched in the at least one heavier component is withdrawn from the second column and a gas enriched in CO₂ and depleted in the at least one heavier component is withdrawn at the top of the second column as product, characterized in that a first part of the liquid enriched in CO₂ is expanded and sent to a second distillation column in the liquid form, a second part of the liquid enriched in CO₂ is vaporized in the first heat exchanger and then sent in the gaseous form into the bottom of the second distillation column at an arrival point, the first part of the liquid being sent to the second column at a level above the arrival point of the second part of the liquid.

According to other optional characteristics:
a third part of the liquid enriched in CO₂ and depleted in the at least one lighter component is vaporized in the first heat exchanger and is returned to the first distillation column,
a part of the gas enriched in CO₂ and depleted in the at least one heavier component is condensed and returned at the top of the second column,
at least a part of the cold for condensing the part of the gas enriched in CO₂ and depleted in the at least one heavier component is produced by a first closed refrigeration cycle,
a compressor of the first refrigeration cycle is driven by a turbine which expands at least a part of a gas depleted in the at least one light component produced by the separation of the feed gas by partial condensation and/or by distillation,
the second and optionally the third part of the liquid enriched in CO₂ and depleted in the at least one lighter component is pressurized by a pump upstream of the first heat exchanger,
a closed refrigeration cycle produces cold for cooling the first heat exchanger,
the compressed and cooled feed gas is separated by partial condensation to produce the gas depleted in CO₂ and also a liquid, and the liquid is separated by distillation in the first distillation column, being sent to the top of the first distillation column,
the second distillation column operates at a higher pressure than the first distillation column, and/or
the second distillation column operates at the same pressure as the first distillation column.

According to another subject matter of the invention, there is provided an appliance for the low-temperature separation of a feed gas containing CO₂, at least one component lighter than CO₂ and at least one component heavier than CO₂ to produce a CO₂-rich fluid, comprising a compressor comprising at least two stages, a first heat exchanger, a first distillation column, a second distillation column, a conduit for sending the feed gas to be compressed in the compressor comprising at least two stages, a conduit for sending the compressed gas to be cooled in the first heat exchanger, means for sending the gas cooled in the first heat exchanger to be separated at low temperature at least by distillation in the first distillation column to produce a liquid enriched in CO₂ and depleted in the component lighter than CO₂ and a gas depleted in CO₂ and enriched in the component lighter than CO₂, a conduit for sending the gas depleted in CO₂ to be heated in the first heat exchanger, an expansion means, a conduit for sending a first part of the liquid enriched in CO₂ to be expanded in the expansion means, means for withdrawing a liquid depleted in CO₂ and enriched in the at least one heavier component from the second column and means for withdrawing a gas enriched in CO₂ and depleted in the at least one heavier component at the top of the second column as product, characterized in that it comprises a conduit for sending the expanded first part to the second distillation column in the liquid form, a conduit for sending a second part of the liquid enriched in CO₂ to be vaporized in the first heat exchanger and a conduit for sending the vaporized second part into the bottom of the second distillation column at an arrival point, the first part of the liquid being sent to the second column at a level above the arrival point of the second part of the liquid.

According to another subject matter of the invention, there is provided an appliance for the low-temperature separation of a feed gas containing CO₂, at least one component lighter than CO₂ and at least one component heavier than CO₂ to produce a CO₂-rich fluid, comprising a compressor comprising at least two stages, a first heat exchanger, a first distillation column, a second distillation column, a conduit for sending the feed gas to be compressed in the compressor comprising at least two stages, a conduit for sending the compressed gas to be cooled in the first heat exchanger, means for sending the gas cooled in the first heat exchanger to be separated at low temperature at least by distillation in the first distillation column to produce a liquid enriched in CO₂ and depleted in the at least one component lighter than CO₂ and a gas depleted in CO₂ and enriched in the at least one component lighter than CO₂, a conduit for sending the gas depleted in CO₂ to be heated in the first heat exchanger, an expansion means, a conduit for sending a first part of the liquid enriched in CO₂ to be expanded in the expansion means, a conduit for sending the expanded first part to the second distillation column in the liquid form, means for withdrawing a liquid depleted in CO₂ and enriched in the at least one heavier component from the second column and means for withdrawing a gas enriched in CO₂ and depleted in the at least one heavier component at the top of the second column as product, a closed refrigeration cycle comprising at least one cycle compressor and comprising at least one product compressor, at least one said cycle compressor and at least one said product compressor being incorporated in a single compression machine.

According to other optional characteristics, the appliance comprises:
a pump for pressurizing the second part of the liquid enriched in CO₂ upstream of the first heat exchanger,
a pump for pressurizing the first part of the liquid enriched in CO₂ upstream of the second distillation column,
a pump for pressurizing a part of the liquid enriched in CO₂ upstream of the first heat exchanger and expansion means for expanding this part of the liquid upstream of the first distillation column,
a phase separator for separating the feed gas cooled in the first heat exchanger and means for sending liquid from the phase separator to the first distillation column,
the means for sending liquid from the phase separator to the first distillation column are connected to the top of the first distillation column,
a single pump for pressurizing the second part of the liquid enriched in CO₂ upstream of the first heat exchanger and the first part of the liquid enriched in CO₂ upstream of the second distillation column, and/or
a single pump for pressurizing the part of the liquid enriched in CO₂ upstream of the first heat exchanger upstream of the first column and the second part of the liquid enriched in CO₂ upstream of the first heat exchanger and/or the first part of the liquid enriched in CO₂ upstream of the second distillation column.

### BRIEF DESCRIPTION OF THE DRAWINGS

These and other features, aspects, and advantages of the present invention will become better understood with regard to the following description, claims, and accompanying drawings. It is to be noted, however, that the drawings illustrate only several embodiments of the invention and are therefore not to be considered limiting of the invention's scope as it can admit to other equally effective embodiments.

FIG. 1 diagrammatically represents the steps which precede a process according to the invention.

FIG. 2 diagrammatically represents a process according to the invention.

FIG. 3 diagrammatically represents a process according to the invention.

### DETAILED DESCRIPTION OF THE INVENTION

The process for the treatment of a gas, for example resulting from combustion, comprises:
the cooling of the gas
the compression of the cooled gas.
the drying of the compressed gas.
the separation of the compressed gas by pressure swing adsorption (denoted by the well-known acronym PSA).
the compression of the waste gas produced by the PSA
the low-pressure separation of the compressed waste gas using cold production means.

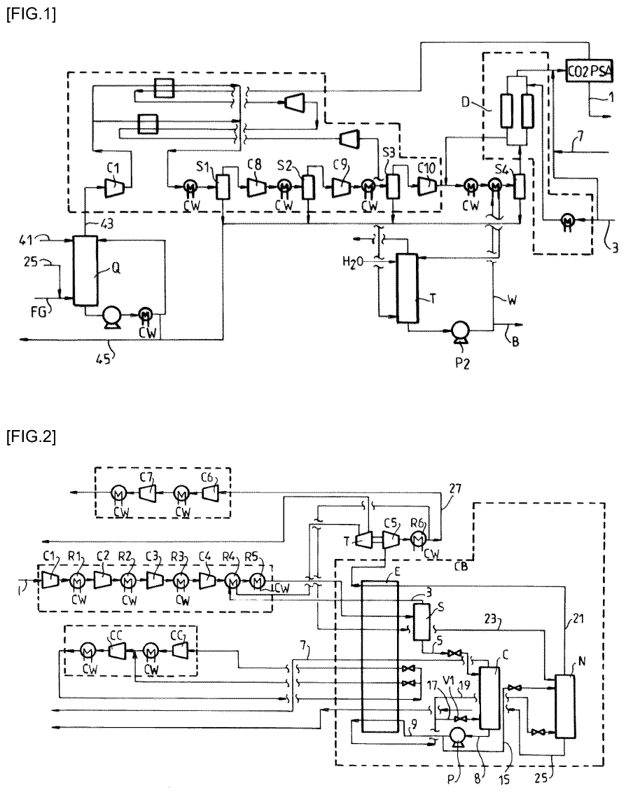

FIG. 1 illustrates the first steps of the process according to an alternative form of the invention.

The gas FG (flue gas) is a combustion gas containing CO₂ and nitrogen. It is cooled in a quench column Q, the water 41 being sent to the top of the column in order to reduce the temperature of the gas FG from 160° C. to ˜40° C. A part of the condensates taken at the bottom of the column Q is cooled against water CW and is recycled as flow 45 to cool the gas FG.

The cooled gas 43 taken at the top of the column Q is saturated with water and is compressed by a multi-stage compressor C1, C8, C9, C10 up to a pressure of approximately 9 bar abs. Most of the water in the gas 43 is thus condensed and the water condensates formed in the separators S1, S2, S3 between the stages are collected to form part of the flow 45.

The compressed gas is subsequently dried by partial condensation after cooling with water CW and cooling with water W originating from a cooling tower T in order to cool the compressed gas down to approximately 10° C. The water condensed in the separator S4 joins the flow 45.

The gas is subsequently dried further in dryers D before sending to the PSA, in this instance indicated as CO₂ PSA, which produces a gas enriched in CO₂ and depleted in nitrogen at a first pressure 1 and a gas depleted in CO₂ but enriched in nitrogen at a second pressure which is higher than the first pressure. Regeneration of the PSA is carried out by a gas 3 which will be described below.

The gas enriched in nitrogen is expanded from approximately 8 bar down to atmospheric pressure, in order to produce a part of the energy for compressing the gas FG. Subsequently, it is used to cool the water H₂O in the tower T before being sent to the air as top gas from the tower T. The cooled water W is pumped by the pump P2 to cool the gas upstream of the separator S4 as already described.

The gas enriched in CO₂ 1 originating from the separation by adsorption in the CO₂ PSA unit is compressed in a compressor up to approximately 39 bar and separated at low temperature, that is to say at a temperature below 0° C., indeed even below −30° C.

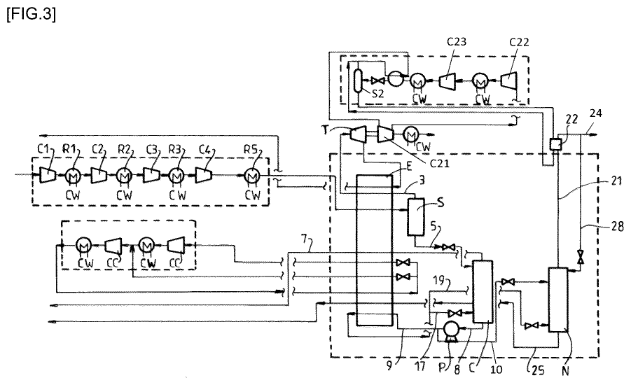

Two different ways of carrying out these next steps will be described in FIG. 2 and FIG. 3.

FIG. 2 diagrammatically represents a process according to the invention.

A gas flow 1 is compressed in a multi-stage compressor, in this instance four stages C1, C2, C3, C4, in this instance with a cooler R1, R2, R3 between each pair of stages and two coolers R4, R5 downstream of the last stage. This flow 1 can, for example, be the waste from an H₂ or CO₂ PSA and can be compressed up to at least 35 bar abs in the stages C1 to C4 of the compressor. The coolers R1 to R3 are cooled solely by the cooling water CW, just like the cooler R5.

The gas flow 1 contains CO₂ and at least one lighter component which can be hydrogen, carbon monoxide, nitrogen or oxygen. In this example, the gas flow is rich in nitrogen. Preferably, the gas flow 1 contains less than 1 mol % of methane.

The gas flow cooled in the two coolers R4, R5 downstream of the last stage is cooled down to a temperature below −50° C. in a first heat exchanger E by exchange of heat with at least one fluid resulting from the cold separation. This exchanger E can be of plate and fin type made of brazed aluminum.

The gas flow 1 partially condenses in the first heat exchanger E and the two-phase flow formed is separated in a phase separator S, forming a gas 3 enriched in the at least one lighter component, in this instance at least nitrogen. This gas is heated in the first exchanger E and subsequently heated in the first cooler R4 directly following the last stage C4 of the compressor from a temperature of 30° C. up to a temperature of 100° C., being the only cooling fluid sent to this first cooler R4. Subsequently, the gas cooled in the first cooler R4 is cooled in a second cooler R5 against cooling water CW to an ambient temperature of less than 40° C., indeed even less than 30° C.

Alternatively, the gas flow 3 enriched in the at least one light component can cool the compressed gas in the second cooler R5, the first being cooled by water.

Alternatively or in addition, the flow enriched in the at least one light component can cool the compressed gas in a cooler R1, R2, R3 between two stages of the compressor.

Thus, the gas 3 to be expanded in a turbine T is preheated against the compressed gas in the compressor C1 to C4, so that the heat of compression makes it possible to produce more energy in the turbine.

The gas flow 3 enriched in light component heated in the first cooler R4 is at 8 bar and is expanded in the turbine T from this pressure down to approximately atmospheric pressure. The gas flow enriched in light component 3 can subsequently be used to regenerate adsorbents for drying the gas feeding the PSA to produce the flow 1. In addition or alternatively, the expanded flow 3 can feed the PSA unit to recover the CO₂ which it contains.

The liquid 5 from the phase separator S is sent to the top of a distillation column C, from which a liquid 9 enriched in CO₂ and depleted in the at least one light component is withdrawn at the bottom. At least a part of the liquid is pressurized by a pump P and can be sent to be vaporized in the first heat exchanger E, a part 11 of the vaporized liquid being optionally sent to the bottom of the column C as reboiling and the other part 19 being sent to feed the column N at the bottom. The top gas 7 from the column C is heated in the first exchanger E.

The pump P can serve simply to overcome the hydrostatic pressure and the head losses, so that the columns C, N operate at the same pressure.

Alternatively, the column C can operate at a higher pressure than the column N, the pressurization of the fluids entering the column by the pump making possible a particularly inexpensive operation.

The column N is a column for the removal of NOx compounds which are heavier than CO₂, NOx being a designation covering the following compounds: nitric oxide (NO), nitrogen dioxide (NO₂), nitrous oxide (N₂O), dinitrogen tetroxide (N₂O₄) and dinitrogen trioxide (N₂O₃). As NO is lighter than CO₂, the column N is used to remove nitrogen dioxide (NO₂), nitrous oxide (N₂O), dinitrogen tetroxide (N₂O₄) and dinitrogen trioxide (N₂O₃), if present in the liquid.

In this column fed by the flow 19, at least one impurity heavier than CO₂ is scrubbed out by an intermediate reflux of CO₂ 15 and a top reflux 23 of pure CO₂ to produce at the bottom a liquid enriched in the at least one heavier impurity 25, such as NOX compounds, for example NO₂.

The liquid enriched in the at least one heavier impurity 25 is vaporized in the first exchanger E.

The top gas 21 from the column N constitutes the product purified in the at least one heavier impurity and is heated in the first exchanger E before being compressed in a first compression stage C5 driven by the turbine T. After cooling in R6, the flow is divided, a part 23 being condensed in the first exchanger E and the remainder 27 being compressed in the compression stages C6, C7 to form a pressurized gaseous product. The gas compressed in C7 constitutes the CO₂-rich gaseous product in this example.

The part 23 is returned at the top of the column N as reflux.

The exchanger E, the phase separator S and the column C are inside a thermally insulated chamber CB.

Two means of cold production are used:
A closed cycle in which CO₂ is compressed in a cycle compressor CC and returned to the first heat exchanger where it is cooled, liquefied, separated and expanded in two different valves to form two flows at 5.5 and 9.5 bar abs. These two flows are heated in the first heat exchanger E to provide cold and are then returned to the cycle compressor CC.
Vaporization of the liquid 9 in the exchanger E.

Obviously, the system can comprise several phase separators, in series and/or in parallel and upstream of the distillation, and also at least one distillation column.

If the system does not include a column separator, the gas expanded in the turbine will be taken at the top of the distillation column.

Preferably, at least one of the cycle compressors CC and at least one product compressor C6, C7 are incorporated in a single compression machine.

FIG. 3 diagrammatically represents another process according to the invention.

A gas flow 1 is compressed in a multi-stage compressor, in this instance four stages C1, C2, C3, C4, in this instance with a cooler R1, R2, R3 between each pair of stages and a single cooler R5 downstream of the last stage C4. This flow 1 is the waste from a CO₂ PSA and can be compressed up to at least 35 bar abs in the stages C1 to C4 of the compressor. The coolers R1 to R3 are cooled solely by the cooling water CW, just like the cooler R5.

The gas flow 1 contains CO₂ and at least one lighter component which can be hydrogen, carbon monoxide, nitrogen or oxygen. In this example, the gas flow is rich in nitrogen. Preferably, the gas flow 1 contains less than 1 mol % of methane.

The gas flow cooled in the cooler R5 downstream of the last stage is cooled down to a temperature below −50° C. in a first heat exchanger E by exchange of heat with at least one fluid resulting from the cold separation. This exchanger E can be of plate and fin type made of brazed aluminum.

The gas flow 1 partially condenses in the first heat exchanger E and the two-phase flow formed is separated in a phase separator S, forming a gas 3 enriched in the at least one lighter component, in this instance at least nitrogen. This gas is heated in the first exchanger E and is subsequently expanded in a turbine T. The gas 3 contains most of the nitrogen present in the flow 1 and also carbon dioxide.

The gas flow 3 enriched in light component heated in the first cooler R4 is at 8 bar and is expanded in the turbine T from this pressure down to approximately atmospheric pressure. The gas flow enriched in light component 3 is subsequently heated in the exchanger E and can be used to regenerate adsorbents for drying the gas feeding the PSA to produce the flow 1. The gas which has been used for the regeneration of the dryers D is mixed with the gas to be separated downstream of the stage C10. In this way, the CO₂ which it contains is recovered and more NOX is absorbed during the partial condensation upstream of the separator S4.

In addition or alternatively, the expanded flow 3 can feed the PSA unit to recover the CO₂ which it contains.

The liquid 5 from the phase separator S is expanded down to approximately 14 bar and sent to the top of a distillation column C, from which a liquid 9 enriched in CO₂ and depleted in the at least one light component is withdrawn at the bottom. The liquid can be pressurized by a pump P or otherwise transferred by virtue of the pressure differential. A part of the liquid is sent to be vaporized in the first heat exchanger E, a part 11 of the vaporized liquid being sent to the bottom of the column C as reboiling and the other part 19 being sent to feed the column N at the bottom in the gaseous form. The remainder of the pressurized liquid is sent as intermediate reflux to the column N in the liquid form.

The top gas 7 from the column C is heated in the first exchanger E and is enriched in light components of the liquid 5, for example oxygen and/or nitrogen and/or methane and/or NO. It can be recycled upstream of the PSA.

The column N is a column for the removal of NOx compounds which are heavier than CO₂, NOx being a designation covering the following compounds: nitric oxide (NO), nitrogen dioxide (NO₂) , nitrous oxide (N₂O), dinitrogen tetroxide (N₂O₄) and dinitrogen trioxide (N₂O₃). As NO is lighter than CO₂, the column N is used to remove nitrogen dioxide (NO₂) , nitrous oxide (N₂O), dinitrogen tetroxide (N₂O₄) and dinitrogen trioxide (N₂O₃), if present in the liquid.

In this column fed by the flow, the at least one impurity heavier than CO₂ is scrubbed out by an intermediate reflux of CO₂ and a top reflux of pure CO₂ to produce at the bottom a liquid enriched in the at least one heavier impurity, such as NOX compounds, for example NO₂.

The liquid 25 enriched in NOx which is heavier than CO₂, such as NO₂ , is withdrawn at the bottom of the column N. The liquid 25 is heated in the exchanger E and then recycled to the combustion gas FG upstream of the column Q.

The compressor C5 driven by the turbine T forms part of a CO₂ or ammonia refrigeration cycle. The gas is subsequently compressed by other compression stages C6, C7, with a water cooler CW between each pair of stages (R6 between C5 and C6) and a last cooler downstream of stage C7.

The top gas 21 from the column N constitutes the CO₂-rich gaseous product in this example. This gas enriched in CO₂ and depleted in the at least one heavy component is condensed in a heat exchanger 22, cooled by the refrigeration cycle C22, C23. A part 28 is returned to the column N as reflux and the remainder 24 of the liquid constitutes a product of the process.

The exchanger E, the phase separator S and the columns C and N are inside a thermally insulated chamber CB.

Three means of cold production are used:
A closed cycle in which CO₂ is compressed in a cycle compressor CC and returned to the first heat exchanger where it is cooled, liquefied, separated and expanded in two different valves to form two flows at 5.5 and 9.5 bar abs. These two flows are heated in the first heat exchanger E to provide cold and are then returned to the cycle compressor CC.
Vaporization of the liquid 9 in the exchanger E.
A closed cycle of CO₂ or ammonia using the compressors C22 and C23.

Obviously, the system can comprise several phase separators, in series and/or in parallel and upstream of the distillation, and also at least one distillation column.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1-15. (canceled)

16. A process for the low-temperature separation of a feed gas containing CO₂, at least one component lighter than CO₂ and at least one component heavier than CO₂ to produce a CO₂-rich fluid, the process comprising the steps of:
compressing the feed gas in a compressor comprising at least two stages to form a compressed gas;
cooling the compressed gas in a first heat exchanger to form a cooled gas;
separating the cooled gas at low temperature at least by distillation in a first distillation column to produce a liquid enriched in CO₂ and depleted in the at least one component lighter than CO₂ and a gas depleted in CO₂ and enriched in the at least one component lighter than CO₂;
heating the gas depleted in CO₂ in the first heat exchanger;
pressurizing the liquid enriched in CO₂ and depleted in the at least one component lighter than CO₂ in a pump;
expanding a first portion of the liquid enriched in CO₂ and depleted in the at least one component lighter than CO₂ and introducing the expanded first portion into a second distillation column in liquid phase;
vaporizing a second part of the liquid enriched in CO₂ in the first heat exchanger and then introducing the vaporized second part in the gaseous phase into first point that is located at a bottom of the second distillation column;
withdrawing a fluid depleted in CO₂ and enriched in the at least one heavier component from a second column; and
withdrawing a top gas enriched in CO₂ and depleted in the at least one heavier component at a top of the second column as product,
wherein the first part of the liquid being sent to the second distillation column is at a level above the first point.

17. The process as claimed in claim 16, wherein a third part of the liquid enriched in CO₂ and depleted in the at least one lighter component is vaporized in the first heat exchanger and is returned to the first distillation column.

18. The process as claimed in claim 16, wherein a part of the gas enriched in CO₂ and depleted in the at least one heavier component is condensed and returned at the top of the second column.

19. The process as claimed in claim 18, wherein at least a part of the cold for condensing the part of the gas enriched in CO₂ and depleted in the at least one heavier component is produced by a first closed refrigeration cycle.

20. The process as claimed in claim 19, wherein a compressor of the first refrigeration cycle is driven by a turbine which expands at least a part of a gas depleted in the at least one light component produced by the separation of the feed gas by partial condensation and/or by distillation.

21. The process as claimed in claim 16, wherein the second and optionally the third part of the liquid enriched in CO₂ and depleted in the at least one lighter component is pressurized by a pump upstream of the first heat exchanger.

22. The process as claimed in claim 16, wherein a closed refrigeration cycle produces cold for cooling the first heat exchanger.

23. The process as claimed in claim 16, wherein the compressed and cooled feed gas is separated by partial condensation to produce the gas depleted in CO₂ and also a liquid, and the liquid is separated by distillation in the first distillation column, being sent to the top of the first distillation column.

24. An appliance for the low-temperature separation of a feed gas containing CO₂ , at least one component lighter than CO₂ and at least one component heavier than CO₂ to produce a CO₂-rich fluid, the apparatus comprising:
a compressor comprising at least two stages;
a first heat exchanger, a first distillation column, a second distillation column;
a first conduit for sending the feed gas to be compressed in the compressor comprising at least two stages;
a second conduit configured to send the compressed gas to be cooled in the first heat exchanger;
means for sending the gas cooled in the first heat exchanger to be separated at low temperature at least by distillation in the first distillation column to produce a liquid enriched in CO₂ and depleted in the at least one component lighter than CO₂ and a gas depleted in CO₂ and enriched in the at least one component lighter than CO₂ ;
a third conduit configured to send the gas depleted in CO₂ to be heated in the first heat exchanger;
an expansion means;
means for withdrawing a liquid depleted in CO₂ and enriched in the at least one heavier component from the second column and means for withdrawing a gas enriched in CO₂ and depleted in the at least one heavier component at the top of the second column as product;
a fourth conduit configured to send a first part of the liquid enriched in CO₂ to be expanded in the expansion means;
a fifth conduit configured to send the expanded first part to the second distillation column in the liquid form;
a sixth conduit configured to send a second part of the liquid enriched in CO₂ to be vaporized in the first heat exchanger; and
a seventh conduit configured to send the vaporized second part into the bottom of the second distillation column at an arrival point, the first part of the liquid being sent to the second column at a level above the arrival point of the second part of the liquid.

25. The appliance as claimed in claim 24, further comprising a closed refrigeration cycle comprising at least one cycle compressor and comprising at least one product compressor, at least one said cycle compressor and at least one said product compressor being incorporated in a single compression machine.

26. The appliance as claimed in claim 24, further comprising a pump for pressurizing the second part of the liquid enriched in CO₂ upstream of the first heat exchanger.

27. The appliance as claimed in claim 24, further comprising a pump for pressurizing the first part of the liquid enriched in CO₂ upstream of the second distillation column.

28. The appliance as claimed in claim 24, further comprising a pump for pressurizing a part of the liquid enriched in CO₂ upstream of the first heat exchanger and expansion means for expanding this part of the liquid upstream of the first distillation column.

29. The appliance as claimed in claim 24, further comprising a phase separator for separating the feed gas cooled in the first heat exchanger and means for sending liquid from the phase separator to the first distillation column.

30. The appliance as claimed in claim 29, wherein the means for sending liquid from the phase separator to the first distillation column are connected to the top of the first distillation column.
